(19) United States
(12) Patent Application Publication
(10) Pub. No.: US 2009/0179506 A1
(43) Pub. Date: Jul. 16, 2009

(54) Encapsulated stator assembly and process for preparation thereof

(76) Inventors: Yuji Saga, Tochigi (JP); Masahiro Matsuzaki, Tochigi (JP); Yoko Matsuzaki, Kawasaki-shi (JP)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 12/288,923

(22) Filed: Oct. 23, 2008

Related U.S. Application Data
(60) Provisional application No. 61/000,541, filed on Oct. 26, 2007.

(51) Int. Cl. H02K 15/12; H02K 3/34

(52) U.S. Cl. 310/45; 29/596; 310/215

(57) ABSTRACT

An encapsulated stator assembly comprising a stator core of laminated electromagnetic steel sheets and containing wire wound coils; an insulator covering the stator core positioned between the stator core and the wire wound coils; wherein an encapsulating polymer composition substantially encapsulates the stator core and the wire wound coils and the insulator and an adhesive component is interfaced between the stator core and the encapsulating polymer composition and wherein the encapsulating polymer composition comprises a thermally conductive polymer composition having a thermal conductivity of at least about 0.6 W/mK. A method for making the encapsulated stator assembly is also part of the invention.

### CROSS REFERENCE TO RELATED APPLICATIONS

This application claims the benefit of U.S. Provisional Application No. 61/000,541, filed Oct. 26, 2007.

### FIELD OF THE INVENTION

The present invention relates to a stator assembly encapsulated with a thermally conductive polymer composition.

### BACKGROUND OF THE INVENTION

Motors having a rotor and stator assembly are used in home appliances, industrial equipment, computer disc drives and hybrid electric vehicles. The components of the motor must be kept clean from contaminating particles and other foreign matter that can interfere with their operation. One method for protecting such motors involves encapsulating the motor with a plastic composition. For example, conventional plastic compositions, such as, a polycarbonate, polystyrene, styrene copolymer, polyolefin, acrylate, acrylic, polyvinyl chloride, polyester, polyphenylene sulfide or polyamide resin can be used to encapsulate the motor. Such conventional plastic compositions are generally effective in protecting the components of the motor from hazardous environmental conditions, such as, exposure to corrosive fluids, contamination from dirt and dust particles, and other materials. Also, such compositions are good electrical insulators and further, these plastic compositions can be used to improve the mechanical integrity and other properties of the motor assembly. However, these conventional plastic compositions have some drawbacks.

Particularly, the motor during operation generates a substantial amount of heat that must be removed in order for the motor to function properly. If the heat is not efficiently dissipated, the motor can overheat resulting in a breakdown of the motor. Conventional plastic compositions generally are good thermal insulators but are inefficient for removing heat and cooling the motor.

To address this problem, plastic compositions having improved thermally conductive properties have been developed. For example, Neal, U.S. Pat. No. 6,362,554 discloses a method of encapsulating a high speed spindle motor that includes a core and a stator having multiple conductors. These conductors create magnetic fields as they conduct electrical current. A thermally-conductive body encapsulates the stator. The '554 patent discloses that a thermally-conductive, but non-electrically-conductive, plastic composition containing filler particles can be used to form the encapsulating body. According to the '554 patent, a preferred plastic is polyphenyl sulfide, and the amount and type of filler can be a ceramic material, glass, Kevlar® aramid fiber from E. I. Du Pont de Nemours and Company, carbon fibers or other fibers.

Although use of such thermally-conductive plastic compositions can be somewhat effective in transferring heat away from the stator assembly compared to the use of general plastic compositions, there is a need for further improvements to aid in the heat transfer between the stator core of the stator assembly of a motor and the encapsulating plastic. The use of an adhesive component intervening between the stator core and the encapsulating plastic improves the heat transfer between them that leads to efficient heat release from the stator assembly.

The present invention provides such a stator assembly encapsulated with a thermally conductive polymer composition that has an adhesive component as an interface between the encapsulated polymer composition and the stator assembly to improve heat release.

### SUMMARY OF THE INVENTION

An encapsulated stator assembly comprising

(a) a stator core comprising laminated electromagnetic steel sheets and wire wound coils;

(b) an insulator that is positioned between the stator core and the wire wound coils;

(c) an encapsulating polymer composition substantially encapsulating the stator core and the wire wound coils and the insulator; and

(d) an adhesive component interfaced between the stator core (a) and the encapsulating polymer composition (c);

wherein the encapsulating polymer composition comprises a thermally conductive polymer composition having a thermal conductivity of at least about 0.6 W/mK.

A process for making the encapsulated stator assembly also is part of this invention.

In another embodiment, the insulator (b) comprises a thermally conductive polymer composition having a thermal conductivity of at least about 0.6 W/mk.

In still another embodiment, the invention comprises a layer of an adhesive component interfaced between the stator core (a) and the insulator (b).

In yet another embodiment, the insulator (b) is over-molded on the stator core and the encapsulating polymer encapsulates the stator core.

In a further embodiment, the invention comprises the adhesive component d) which is a primer coated on the stator core.

In a still further embodiment, the invention comprises a primer containing a coupling agent selected from the group of silane, titanate, zirconate, aluminate, and zircoaluminate.

In yet a still further embodiment, the invention comprises a thermally conductive polymer having groups which can react with the coupling agents of the primer.

In yet another embodiment, the invention comprises a motor comprising the encapsulated stator assembly.

In still yet another embodiment, the invention comprises a generator comprising the encapsulated stator assembly.

### BRIEF DESCRIPTION OF THE FIGURES

FIG. 1 is a perspective view of the stator core with coils of wire wound windings.

FIG. 2 is a perspective view of the stator assembly that is made by encapsulating the stator core shown in FIG. 1 with a thermally conductive polymer composition.

FIG. 3 is a cross section view of the laminated steel stator core having an encapsulating polymer composition with an adhesive interface between the stator core and the encapsulating polymer composition.

FIG. 4 is a view of the experiment used to measure the effect of the adhesive component on heat flow from the heat source through a metal stator core and the encapsulated polymer composition.

FIG. 5 shows the temperature rise of the metal stator core when the encapsulated stator core is exposed to a heat source.

### DETAILED DESCRIPTION OF THE INVENTION

The present invention relates to a stator assembly encapsulated with a thermally conductive polymer composition and having an adhesive layer between the core of the stator assembly and the encapsulated polymer composition. It is known that thermally conductive polymers can be used to dissipate heat from the stator assembly as disclosed in U.S. Pat. No. 6,362,554. However, the use of a thermally conductive polymer alone is not enough to provide a stator assembly with a sufficiently high level of heat dissipation. The present invention provides a stator assembly having a high level of heat dissipation by the application of an adhesive layer component at the interface of the stator core and the encapsulating polymer composition that is thermally conductive in comparison to a stator assembly only having an encapsulating layer of a thermally conductive polymer.

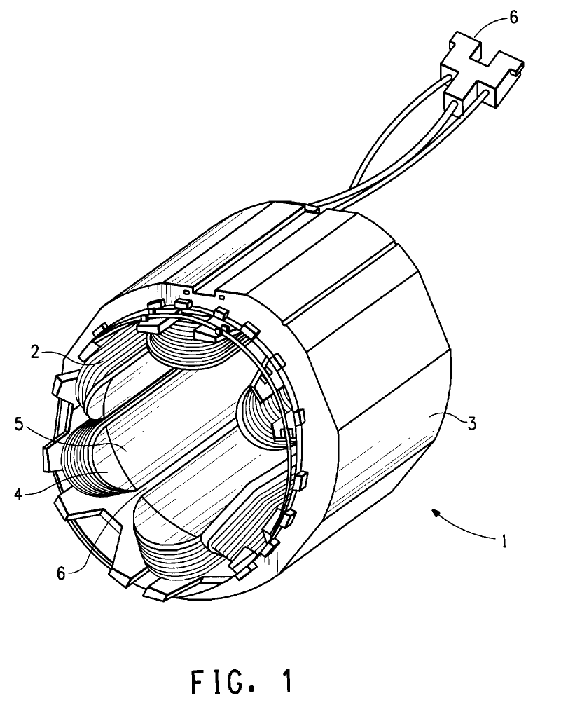

FIG. 1 shows a stator assembly (1) before being encapsulated with a thermally conductive polymer composition that includes a laminated steel core (3), coil winding (2) positioned in close relation to the steel core (3), an insulator (4), and an electrical connector assembly (6). The coil winding (2) is positioned on tooth (5) of the stator assembly.

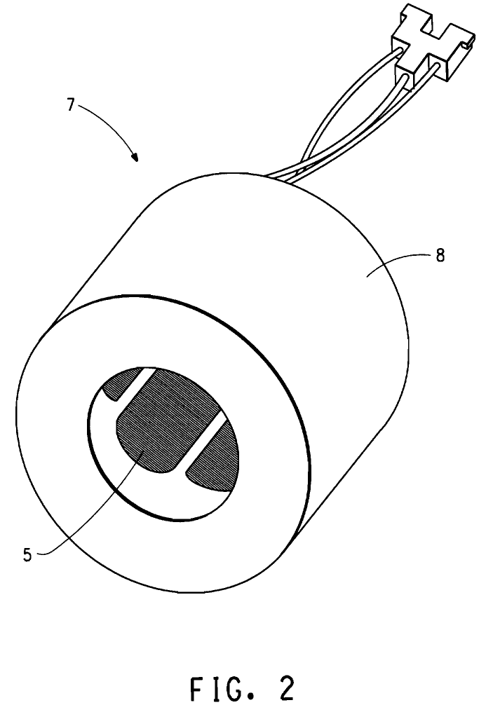

FIG. 2 is a perspective view of the encapsulated stator assembly (7) of FIG. 1 and shows an encapsulating layer (8) of a thermally conductive polymer composition and tooth (5) on which a coil winding (not shown) is positioned.

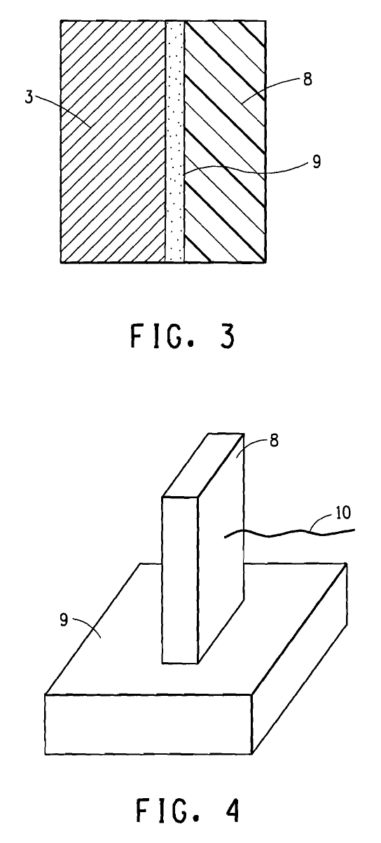

FIG. 3 shows a cross section view the laminated steel stator core (3) having an encapsulating layer (8) of a thermally conductive polymer composition with an adhesive interface (9) between the stator core (3) and the encapsulating layer (8).

### Thermally Conductive Polymer Composition

The insulator (4) and the encapsulating layer (8) can be the same or a different thermally conductive polymer composition. The insulator and the encapsulating polymer composition are each formulated to have the physical properties required for each use.

The thermally conductive polymer composition used to form the insulator and the encapsulating polymer layer for the stator assembly of this invention is electrically insulating and thermally conductive and comprises a base polymer and a thermally conductive filler material and has a thermal conductivity of at least about 0.6 W/mk and up to about 100 W/mk and preferably, at least about 0.6 W/mk and up to about 10 W/mk and more preferably, from 0.6 W/mk to 5 W/mk. Preferably, the thermally conductive polymer composition comprises about 10 to 80 volume percent of the base polymer and about 90 to 20 volume percent of the thermally conductive filler material and more preferably about 30 to 70 volume percent of the base polymer and 70 to 30 volume percent of the thermally conductive filler material. It is desirable to provide a thermally conductive polymer composition that has a high conductivity but this must be balanced with the moldability of the composition and the costs of the conductive filler materials.

A variety of thermoplastic and thermosetting polymers can be used to form the thermally conductive polymer compositions for these two components. For example, useful thermoplastic polymers can be selected from the following group of polymers: polycarbonate, polyethylene, polypropylene, acrylics, vinyls, injection moldable fluoropolymers (PFA), polyamides, polyesters, polysulfones, polyphenylene sulfide, liquid crystal polymers, such as, thermoplastic aromatic polyesters, polyetherimides, polyamidimides, and blends thereof. Alternatively, thermosetting polymers, such as, elastomers, epoxies, polyimides, silicones, unsaturated polyester and polyurethanes can be used. Polymers having groups, such as, carboxy, amino, epoxy, hydroxyl, and acid anhydride which can react with the adhesive components are preferred.

Preferred polymers for the thermally conductive composition are thermoplastic polymers and more preferred are polyesters, polyamide and liquid crystal polymers.

Preferred thermoplastic polyesters include polyesters having an inherent viscosity of 0.3 or greater and that are, in general, linear saturated condensation products of diols and dicarboxylic acids, or reactive derivatives thereof. Preferably, these polyesters are the condensation products of aromatic dicarboxylic acids having 8 to 14 carbon atoms and at least one diol selected from the group consisting of neopentyl glycol, cyclohexanedimethanol, 2,2-dimethyl-1,3-propane diol and aliphatic glycols of the formula HO(CH₂)ₙOH where n is an integer of 2 to 10. Up to 20 mole percent of the diol may be an aromatic diol such as ethoxylated bisphenol A, sold as Dianol® 220 by Akzo Nobel Chemicals, Inc.; hydroquinone; biphenol; or bisphenol A. Up to 50 mole percent of the aromatic dicarboxylic acids can be replaced by at least one different aromatic dicarboxylic acid having from 8 to 14 carbon atoms, and/or up to 20 mole percent can be replaced by an aliphatic dicarboxylic acid having from 2 to 12 carbon atoms. Copolymers may be prepared from two or more diols or reactive equivalents thereof and at least one dicarboxylic acid or reactive equivalent thereof or two or more dicarboxylic acids or reactive equivalents thereof and at least one diol or reactive equivalent thereof. Difunctional hydroxy acid monomers, such as, hydroxybenzoic acid or hydroxynaphthoic acid or their reactive equivalents may also be used as comonomers.

Preferred polyesters include poly(ethylene terephthalate) (PET), poly(1,4-butylene terephthalate) (PBT), poly(propylene terephthalate) (PPT), poly(1,4-butylene naphthalate) (PBN), poly(ethylene naphthalate) (PEN), poly(1,4-cyclohexylene dimethylene terephthalate) (PCT), and copolymers and mixtures of the foregoing. Also, preferred are 1,4-cyclohexylene dimethylene terephthalate/isophthalate copolymer and other linear homopolymer esters derived from aromatic dicarboxylic acids, including isophthalic acid; bibenzoic acid; naphthalenedicarboxylic acids including the 1,5-; 2,6-; and 2,7-naphthalenedicarboxylic acids; 4,4′-diphenylenedicarboxylic acid; bis(p-carboxyphenyl) methane; ethylene-bis-p-benzoic acid; 1,4-tetramethylene bis(p-oxybenzoic) acid; ethylene bis(p-oxybenzoic) acid; 1,3-trimethylene bis(p-oxybenzoic) acid; and 1,4-tetramethylene bis(p-oxybenzoic) acid, and glycols selected from the group consisting of 2,2-dimethyl-1,3-propane diol; neopentyl glycol; cyclohexane dimethanol; and aliphatic glycols of the general formula HO(CH₂)ₙOH where n is an integer from 2 to 10, e.g., ethylene glycol; 1,3-trimethylene glycol; 1,4-tetramethylene glycol; -1,6-hexamethylene glycol; 1,8-octamethylene glycol; 1,10-decamethylene glycol; 1,3-propylene glycol; and 1,4-butylene glycol. Up to 20 mole percent, as indicated above, of one or more aliphatic acids, including adipic, sebacic, azelaic, dodecanedioic acid or 1,4-cyclohexanedicarboxylic acid can be present. Also preferred are copolymers derived from 1,4-butanediol, ethoxylated bisphenol A, and terephthalic acid or reactive equivalents thereof. Also preferred are random copolymers of at least two of PET, PBT, and PPT, and mixtures of at least two of PET, PBT, and PPT, and mixtures of any of the forgoing.

The thermoplastic polyester may also be in the form of copolymers that contain poly(alkylene oxide) soft segments. The poly(alkylene oxide) segments are to be present in about 1 to about 15 parts by weight per 100 parts per weight of thermoplastic polyester. The poly(alkylene oxide) segments have a number average molecular weight in the range of about 200 to about 3,250 or, preferably, in the range of about 600 to about 1,500. Preferred copolymers contain poly(ethylene oxide) incorporated into a PET or PBT chain. Methods of incorporation are known to those skilled in the art and can include using the poly(alkylene oxide) soft segment as a comonomer during the polymerization reaction to form the polyester. PET may be blended with copolymers of PBT and at least one poly(alkylene oxide). A poly(alkyene oxide) may also be blended with a PET/PBT copolymer. The inclusion of a poly(alkylene oxide) soft segment into the polyester portion of the composition may accelerate the rate of crystallization of the polyester.

More preferred polyamides include polyamide 6, polyamide 66, polyamide 612, polyamide 610, or other aliphatic polyamides and semi-aromatic polyamides, such as those derived from terephthalic acid and/or isophthalic acid. Examples include polyamides 6T66, 6TDT, 9T, 10T, 12T, polyamides derived from hexamethylenediamine, adipic acid, and terephthalic acid; and polyamides derived from hexamethylenediamine, 2-methylpentamethylenediamine, and terephthalic acid. Blends of two or more polyamides may be used.

By a “liquid crystalline polymer” (abbreviated “LCP”) is meant a polymer that is anisotropic when tested using the TOT test or any reasonable variation thereof, as described in U.S. Pat. No. 4,118,372, which is hereby included by reference. Useful LCP's include polyesters, poly(ester-amides), and poly(ester-imides). One preferred form of LCP is “all aromatic”, that is all of the groups in the polymer main chain are aromatic (except for the linking groups such as ester groups), but side groups which are not aromatic may be present.

The thermally conductive polymer composition can include polymeric toughening agent as a component in the present invention.

When the thermoplastic polymer is a polyester, the toughening agent will typically be an elastomer or has a relatively low melting point, generally <200° C., preferably <150° C. and that has attached to it functional groups that can react with the thermoplastic polyester (and optionally, other polymers present). Since thermoplastic polyesters usually have carboxyl and hydroxyl groups present, these functional groups usually can react with carboxyl and/or hydroxyl groups. Examples of such functional groups include epoxy, carboxylic anhydride, hydroxyl (alcohol), carboxyl, and isocyanate. Preferred functional groups are epoxy, and carboxylic anhydride, and epoxy is especially preferred. Such functional groups are usually “attached” to the polymeric toughening agent by grafting small molecules onto an already existing polymer or by copolymerizing a monomer containing the desired functional group when the polymeric tougher molecules are made by copolymerization. As an example of grafting, maleic anhydride may be grafted onto a hydrocarbon rubber using free radical grafting techniques. The resulting grafted polymer has carboxylic anhydride and/or carboxyl groups attached to it. An example of a polymeric toughening agent wherein the functional groups are copolymerized into the polymer is a copolymer of ethylene and a (meth)acrylate monomer containing the appropriate functional group.

By (meth)acrylate herein is meant the compound may be either an acrylate, a methacrylate, or a mixture of the two. Useful (meth)acrylate functional compounds include (meth)acrylic acid, 2-hydroxyethyl (meth)acrylate, glycidyl(meth)acrylate, and 2-isocyanatoethyl (meth)acrylate. In addition to ethylene and a functional (meth)acrylate monomer, other monomers may be copolymerized into such a polymer, such as vinyl acetate, unfunctionalized (meth)acrylate esters, such as, ethyl (meth)acrylate, n-butyl(meth)acrylate, and cyclohexyl(meth)acrylate. Preferred toughening agents include those listed in U.S. Pat. No. 4,753,980, which is hereby included by reference. Especially preferred toughening agents are copolymers of ethylene, ethyl acrylate or n-butyl acrylate, and glycidyl methacrylate.

It is preferred that the polymeric toughening agent used with thermoplastic polyesters contain about 0.5 to about 20 weight percent of monomers containing functional groups, preferably about 1.0 to about 15 weight percent, more preferably about 7 to about 13 weight percent of monomers containing functional groups. There may be more than one type of functional monomer present in the polymeric toughening agent. It has been found that toughness of the composition is increased by increasing the amount of polymeric toughening agent and/or the amount of functional groups. However, these amounts should preferably not be increased to the point that the composition may crosslink, especially before the final part shape is attained.

The polymeric toughening agent used with thermoplastic polyesters may also be thermoplastic acrylic polymers that are not copolymers of ethylene. The thermoplastic acrylic polymers are made by polymerizing acrylic acid, acrylate esters (such as, methyl acrylate, n-propyl acrylate, isopropyl acrylate, n-butyl acrylate, n-hexyl acrylate, and n-octyl acrylate), methacrylic acid, and methacrylate esters (such as, methyl methacrylate, n-propyl methacrylate, isopropyl methacrylate, n-butyl methacrylate, isobutyl methacrylate, n-amyl methacrylate, n-octyl methacrylate, glycidyl methacrylate (GMA) and the like). Copolymers derived from two or more of the forgoing types of monomers may also be used, as well as copolymers made by polymerizing one or more of the forgoing types of monomers with styrene, acryonitrile, butadiene, isoprene, and the like. Part or all of the components in these copolymers should preferably have a glass transition temperature of not higher than 0° C. Preferred monomers for the preparation of a thermoplastic acrylic polymer toughening agent are methyl acrylate, n-propyl acrylate, isopropyl acrylate, n-butyl acrylate, n-hexyl acrylate, and n-octyl acrylate.

It is preferred that a thermoplastic acrylic polymer toughening agent have a core-shell structure. The core-shell structure is one in which the core portion preferably has a glass transition temperature of 0° C. or less, while the shell portion is preferably has a glass transition temperature higher than that of the core portion. The core portion may be grafted with silicone. The shell section may be grafted with a low surface energy substrate such as silicone, fluorine, and the like. An acrylic polymer with a core-shell structure that has low surface energy substrates grafted to the surface will aggregate with itself during or after mixing with the thermoplastic polyester and other components of the composition of the invention and can be easily uniformly dispersed in the composition.

Suitable toughening agents for polyamides are described in U.S. Pat. No. 4,174,358. Preferred toughening agents include polyolefins modified with a compatibilizing agent, such as, an acid anhydride, dicarboxylic acid or derivative thereof, carboxylic acid or derivative thereof, and/or an epoxy group. The compatibilizing agent may be introduced by grafting an unsaturated acid anhydride, dicarboxylic acid or derivative thereof, carboxylic acid or derivative thereof, and/or an epoxy group to a polyolefin. The compatibilizing agent may also be introduced while the polyolefin is being made by copolymerizing with monomers containing an unsaturated acid anhydride, dicarboxylic acid or derivative thereof, carboxylic acid or derivative thereof, and/or an epoxy group. The compatibilizing agent preferably contains from 3 to 20 carbon atoms. Examples of typical compounds that may be grafted to (or used as comonomers to make) a polyolefin are acrylic acid, methacrylic acid, maleic acid, fumaric acid, itaconic acid, crotonic acid, citrconic acid, maleic anhydride, itaconic anhydride, crotonic anhydride and citraconic anhydride.

When used, the polymeric toughening agent will preferably be present in about 0.5 to about 30 volume percent, or more preferably in about 1 to about 20 volume percent, based on the total volume of the composition.

In the present invention, thermally-conductive filler materials are added to the base polymer to form thermally conductive polymer composition. These materials impart thermal conductivity to the non-conductive base polymer. Examples include ceramic powders, including aluminum oxide, magnesium oxide, boron nitride, aluminum nitride, silicon nitride, calcium fluoride, zinc oxide, glass fibers, and ceramic fibers, such as, alumina fibers, calcium titanate fibers, and silicon nitride fibers.

The thermally-conductive filler materials can be in the form of particles, granular powder, whiskers, fibers, or any other suitable form. The particles or granules can have a variety of structures and a broad particle size distribution. For example, the particles or granules can have flake, plate, rice, strand, hexagonal, or spherical-like shapes with a particle size up to about 200 microns. As another example, the fibers can have a length up to about 3 millimeters.

The surface of the thermally conductive filler material can be modified with a chemical agent having groups which can react with the polymer composition. For example, coupling agents, such as, silane, titanate, zirconate, aluminate and zircoaluminate can be used for the modification of the thermally conductive materials. Typically, about 0.5 wt. % to about 5.0 wt. %, based on the thermally conductive material, of the coupling agent is used.

An optional reinforcing material can be added to the thermally conductive polymer composition. The reinforcing material can be glass, inorganic minerals, or other suitable strengthening material. The reinforcing material strengthens the polymer composition. The reinforcing material, if added, constitutes about 3% to about 25% by volume of the composition.

Further, electrically-conductive materials in small amounts (about 1% to about 10% based) based on volume of composition can be added in order to increase thermal conductivity. However, it is important that the total electrical resistivity of the composition be kept at 10¹⁴ ohm-cm or greater. For example, copper, copper alloys, such as, copper-tin, and graphite can be added.

The thermally conductive polymer composition optionally may include one or more plasticizers, nucleating agents, flame retardants, flame retardant synergists, heat stabilizers, antioxidants, dyes, pigments, mold release agents, lubricants, UV stabilizers, adhesion promoters and the like.

The thermally conductive polymer compositions used in the present invention are in the form of a melt-mixed or a solution-mixed blend, wherein all of the polymeric components are well-dispersed within each other and all of the non-polymeric ingredients are homogeneously dispersed in and bound by the polymer matrix, such that the blend forms a unified whole. The blend may be obtained by combining the component materials using any melt-mixing method or by mixing components other than matrix polymer with monomers of the polymer matrix and then polymerizing the monomers. The component materials may be mixed to homogeneity using a melt-mixer such as a single or twin-screw extruder, blender, kneader, Banbury mixer, etc. to give a resin composition. Part of the materials may be mixed in a melt-mixer, and the rest of the materials may then be added and further melt-mixed until homogeneous. The sequence of mixing in the manufacture of the thermally conductive polymer composition of this invention may be such that individual components may be melted in one shot, or the filler and/or other components may be fed from a side feeder, and the like, as will be understood by those skilled in the art.

### Adhesive Component

Useful adhesive components used in the invention as an interface between the stator core and the encapsulating layer of the thermally conductive polymer composition include compounds capable of adhering to both the surface of the stator core and the thermally conductive polymer composition. Also, an adhesive component preferably is used between the stator core and the over-molded insulator. Examples include various compounds based on silane, titanate, zirconate, aluminate and zircoaluminate.

Useful titanium based compounds include, but are not limited to, monoalkoxy titanates, such as, isopropyl tri(N-ethylaminoethylamino) titanate, isopropyl tri-isostearoyl titanate and titanium di(dioctylpyrophosphate)oxyacetate; coordinate titanates, such as, tetraisopropyl di(dioctylphosphito)titanate; and neoalkoxy titanates, such as, neoalkoxy tris(dodecanoyl) benzenes sulfonyl zirconate, neoalkoxy tri(p-N-(beta-aminoethyl)aminophenyl)titanate. Other types include chelate, quaternary and cycloheteroatom titanates.

Useful zirconium based compounds include, but are not limited to, neoalkoxy zirconates, such as, neoalkoxy trisneodecanoyl zirconate, neoalkoxy tris(dodecanoyl) benzene sulfonyl zirconate, neoalkoxy tris(m-aminophenyl) zirconate, ammonium zirconium carbonate and zirconium propionate.

Useful silicon based compounds include a wide variety of silanes. One type of useful silane is represented by the formula

R₄₋ₙSiKₙ (I)

wherein R is an alkyl or aryl group, or a functional group represented by the formula

CₓH₂ₓY (II)

wherein x is from 0 to 20 and Y is selected from the group consisting of amino, amido, hydroxy, alkoxy, halo, mercapto, carboxy, acyl, vinyl, allyl, styryl, epoxy, isocyanato, glycidoxy and acryloxy groups. K is a hydrolyzable group, such as, alkoxy (e.g., methoxy, ethoxy, and the like), phenoxy, acetoxy, and the like, or halogen (e.g., chlorine); and n is 1, 2, 3 or 4, and preferably n is 3.

The adhesive components represented by formula (I) include halosilanes, aminoalkoxysilanes, aminophenylsilanes, phenylsilanes, heterocyclic silanes, N-heterocyclic silanes, acrylic silanes and mercapto silanes. Mixtures of two or more silanes also are useful. In one embodiment K is OR wherein R is an alkyl group containing up to about 5 carbon atoms or an aryl group containing up to about 8 carbon atoms. In other embodiments x is an integer from 0 to 10 and more often from 1 to about 5.

The adhesive component can be an epoxy silane represented by the formula III.

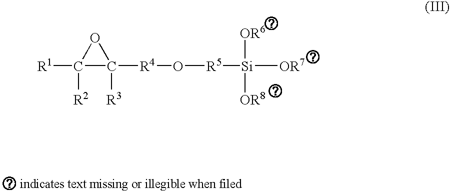

wherein: R¹, R² and R³ are independently hydrogen or hydrocarbon groups; R⁴ and R⁵ are independently alkylene or alkylidene groups; and R⁶, R⁷ and R⁸ are independently hydrocarbon groups. The hydrocarbon groups preferably contain 1 to about 10 carbon atoms, more preferably 1 to about 6 carbon atoms, more preferably 1 to about 4 carbon atoms. These hydrocarbon groups are preferably alkyl. The alkylene or alkylidene groups R⁴ and R⁵ preferably contain from 1 to about 10 carbon atoms, more preferably 1 to about 6 carbon atoms, more preferably 1 to about 4 carbon atoms, more preferably 1 or 2 carbon atoms. The alkylene and alkylidene groups can be methylene, ethylene, propylene, and the like.

The adhesive component can also be an acrylic silane represented by the formula IV.

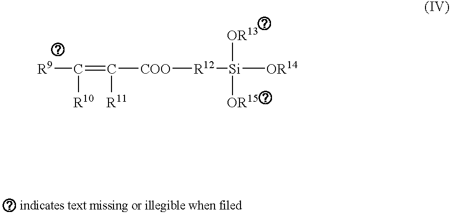

wherein: R⁹, R¹⁰ and R¹¹ are independently hydrogen or hydrocarbon groups; R¹² is an alkylene or alkylidene group; and R¹³, R¹⁴ and R¹⁵ are independently hydrocarbon groups. The hydrocarbon groups preferably contain 1 to about 10 carbon atoms, more preferably 1 to about 6 carbon atoms, more preferably 1 to about 4 carbon atoms. These hydrocarbon groups are preferably alkyl (e.g., methyl, ethyl, propyl, and the like). The alkylene and alkylidene groups preferably contain from 1 to about 10 carbon atoms, more preferably 1 to about 6 carbon atoms, more preferably 1 to about 4 carbon atoms. The alkylene groups include methylene, ethylene, propylene, and the like

The adhesive component additionally can be an amino silane represented by the formula V

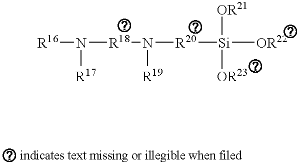

wherein: R¹⁶, R¹⁷ and R¹⁹ are independently hydrogen or hydrocarbon groups; R¹⁸ and R²⁰ are independently alkylene or alkylidene groups; R²¹, R²² and R²³ are independently hydrocarbon groups. The hydrocarbon groups preferably contain 1 to about 10 carbon atoms, more preferably 1 to about 6 carbon atoms, more preferably 1 to about 4 carbon atoms. These hydrocarbon groups are preferably alkyl (e.g., methyl, ethyl, propyl, and the like). The alkylene and alkylidene groups preferably contain from 1 to about 10 carbon atoms, more preferably 1 to about 6 carbon atoms, more preferably 1 to about 4 carbon atoms. The alkylene groups include methylene, ethylene, propylene, and the like.

Mercapto silane adhesive components can be represented by the formula VI

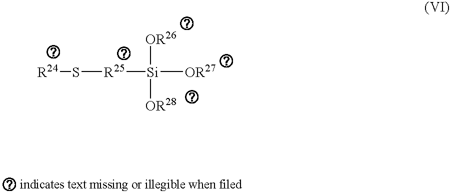

wherein R²⁴ is hydrogen or a hydrocarbon group; R²⁵ is an alkylene or alkylidene group; and R²⁶, R²⁷ and R²⁸ are independently hydrocarbon groups. The hydrocarbon groups preferably contain 1 to about 10 carbon atoms, more preferably 1 to about 6 carbon atoms, more preferably 1 to about 4 carbon atoms. These hydrocarbon groups are preferably alkyl (e.g., methyl, ethyl, propyl, and the like). The alkylene and alkylidene groups preferably contain from 1 to about 10 carbon atoms, more preferably 1 to about 6 carbon atoms, more preferably 1 to about 4 carbon atoms. These groups are preferably alkylene (e.g., methylene, ethylene, propylene, and the like).

Vinyl adhesive components can be represented by the formula VII

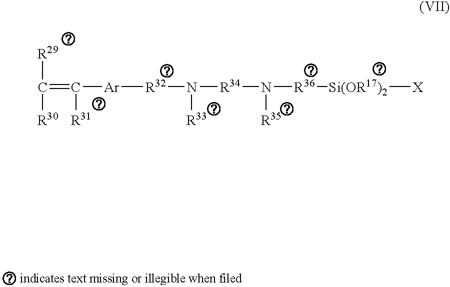

wherein: R²⁹, R³⁰, R³¹, R³³ and R³⁷ are independently hydrogen or hydrocarbon groups; R³², R³⁴ and R³⁶ are independently alkylene or alkylidene groups; each R³⁷ is independently a hydrocarbon group; Ar is an aromatic group; and X is a halogen. The hydrocarbon groups preferably contain 1 to about 10 carbon atoms, more preferably 1 to about 6 carbon atoms, more preferably 1 to about 4 carbon atoms. The hydrocarbon groups are preferably alkyl (e.g., methyl, ethyl, propyl, and the like). The alkylene and alkylidene groups preferably contain from 1 to about 10 carbon atoms, more preferably 1 to about 6 carbon atoms, more preferably 1 to about 4 carbon atoms. These groups are preferably alkylene (e.g., methylene, ethylene, propylene, and the like). The aromatic group Ar can be mononuclear (e.g., phenylene) or polynuclear (e.g., naphthylene) with the mononuclear groups and especially phenylene being preferred. The halogen, X, is preferably chlorine or bromine, more preferably chlorine.

The adhesive components can be a bis-silane represented by the formula VIII

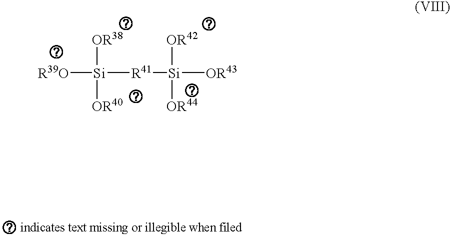

wherein R³⁸, R³⁹, R⁴⁰, R⁴², R⁴³ and R⁴⁴ are independently hydrocarbon groups; R⁴¹ is an alkylene or alkylidene group. The hydrocarbon groups preferably contain 1 to about 10 carbon atoms, more preferably 1 to about 6 carbon atoms, more preferably 1 to about 4 carbon atoms. These hydrocarbon groups are preferably alkyl (e.g., methyl, ethyl, propyl, and the like). The alkylene and alkylidene group preferably contains from 1 to about 10 carbon atoms, more preferably 1 to about 6 carbon atoms, more preferably 1 to about 4 carbon atoms. R⁴¹ group is preferably alkylene (e.g., methylene, ethylene, propylene, and the like).

Useful adhesive components of zircoaluminate compounds include, but are not limited to, compounds presented by the formula IX.

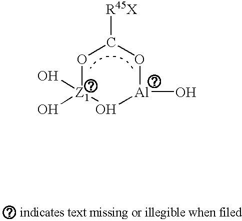

wherein R⁴⁵ is an alkylene or alkylidene group. The alkylene and alkylidene groups preferably contain from 1 to about 10 carbon atoms, more preferably 1 to about 6 carbon atoms, more preferably 1 to about 4 carbon atoms. The alkylene groups include methylene, ethylene, propylene, and the like. X is groups which can react with a group of base polymers of the composition b). Examples are NH₂, COOH and SH.

The adhesive components can be coated on the stator core by, but are not limited to, dipping, spraying and spin coating methods. In the coating process, the adhesive components may be dissolved into a medium, such as, methanol, ethanol and isopropyl alcohol to allow for application of a uniform coat on the metal surface of the stator core. After coating, the adhesive components on the stator core may be dried to enhance curing the adhesive components.

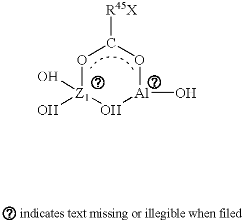

Another example of utilizing the adhesive components is to blend the adhesive components with the thermally conductive polymer compositions and then encapsulate stator core with the blend.

The surface of the stator core can be modified by oxidation or hydroxylation to improve reactivity with the adhesive components as will be understood by those skilled in the art.

Prior to encapsulating the stator assembly with the thermally conductive polymer composition, parts of the stator core assembly can be over-molded with a thermally conductive polymer composition to form an insulating layer over such parts of the stator, typically multiple poles of the stator assembly are covered. Injection molding or insert molding processes can be used. An adhesive layer can be used between the stator core parts and the insulating layer. In the insert molding process, the stator assembly is placed within the mold for the insulator. The molten polymer composition is injected into the mold so that the composition substantially covers the stator assembly and in general covers the multiple poles of the stator core where wire is wound to form a coil after an over-molding process.

In accordance with this invention, the thermally conductive polymer composition can be shaped into a housing which substantially encapsulates the stator core and the wire wound coils and the insulator using an injection or insert molding process after treatment of the stator core with adhesive component d). In the insert molding process, the stator is placed within the mold for the housing. The molten polymer composition is injected into the mold so that the composition surrounds and is disposed about the stator. It should be recognized that it is not necessary for the molten composition to completely encapsulate the stator. Some minor surfaces of the stator may remain exposed.

The encapsulated stator assembly of this invention has many advantageous features over conventional assemblies. One of advantages is, the assembly has improved thermal conductivity properties. The heat transfer properties of the combination of thermally conductive polymer composition and adhesive layer allow for the removal of heat from the coil (2) (see FIGS. 1 and 2) wherein heat is generated and builds up quickly from the operation of the motor or generator and from the stator core wherein heat is stored by absorbing heat from the coil through the insulator. It is very desirable to keep the temperature of the stator core low through the release of heat from the stator core to the outside through the encapsulating thermally conductive polymer layer. The temperature difference between the coil and the stator core is the driving force for the transfer of heat. The insulator allows for the efficient transfer of heat from the coil to the stator core and prevents overheating of the motor or generator during operation.

In this manner, it is important to transfer heat between the stator core a) and the polymer composition c) with the adhesive component d) which provides for improved heat transfer.

It is appreciated by those skilled in the art that various changes and modifications can be made to the description and illustrated embodiments herein without departing from the spirit of the present invention. All such modifications and changes are intended to be covered by the appended claims.

The following Examples illustrate the invention.

### EXAMPLES

The effectiveness of the adhesive components in the interface between the stator core and thermally conductive polymer composition for enhancing heat transfer is demonstrated by the following:

A thermally conductive polymer composition was prepared by melt blending the ingredients shown in Table 1 in a kneading extruder at temperatures of about 330-360° C. Upon exiting the extruder, the composition was cooled and pelletized. The resulting composition was injection molded into test pieces having dimensions 100 mm×100 mm×3.2 mm for thermal conductivity measurements. Thermal conductivity of the composition was measured by Hot Disk Method and the results are shown in Table 1.

40 mm×23 mm×8 mm size SUS304 (stainless steel) block was dipped in Primer 1 which comprises organosilane mixture, that is supplied as APZ-6601 from Dow Corning Toray Co., Ltd, and dried at 100° C. for 10 minutes.

The SUS block coated with organosilane for Example 1 and non-coated SUS block for Comparative Example 1 were encapsulated by injection molding with the thermally conductive polymer composition resulting in a 1 mm thick encapsulating layer. Thus, the dimensions of the encapsulated blocks were 42 mm×25 mm×10 mm.

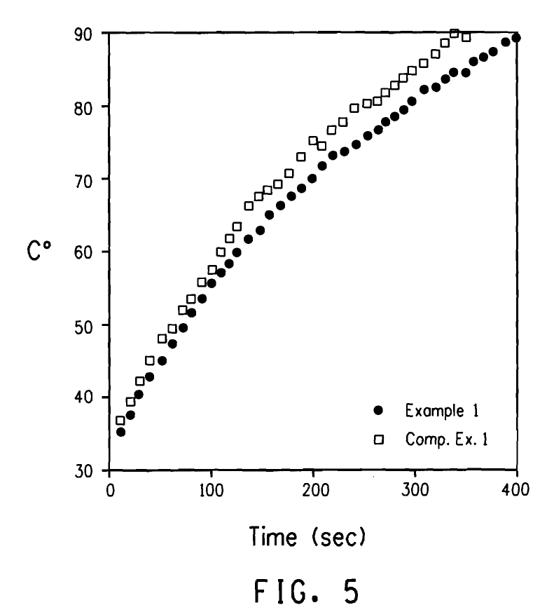

After incubation at 23° C. for a day (24 hours), the encapsulated blocks (10) (see FIG. 4) were put on the hot plate (11) which was controlled to keep its surface temperature at 200° C. Rise of temperature of the inner encapsulated block (SUS304) was monitored by the thermocouple probe (12) inserted into the core SUS304, and the temperature was recorded by 10 seconds interval. As seen from FIG. 5, the temperature of SUS304 encapsulated with the thermally conductive polymer and having the organosilane adhesive component (Example 1, the invention), rose faster than that of the encapsulated block but without any adhesive component (Comparative Example 1). This result indicates that the adhesive component enhances the heat transfer between the encapsulated thermally conductive polymer composition and inner SUS304 metal block.

This means a motor or generator having a stator assembly comprising:

a stator core made of laminated electromagnetic steel sheets and containing wire wound coils that is encapsulated with a thermally conductive polymer composition having a thermal conductivity of at least about 0.6 W/mK; and having an adhesive component interfaced between the stator core a) and the encapsulating thermally conductive polymer releases heat generated in the coil of a motor efficiently.

The following ingredients for Composition 1 are shown in Table 1 following:

HTN: ZytelHTN® 501 supplied by E.I. du Pont de Nemours and Company.

Modified-EPDM: EPDM (ethylene/propylene/diene polyolefin) grafted with maleic anhydride supplied by E.I. du Pont de Nemours and Company.

Talc: HTP2c supplied by Tomoe Kogyo.

TABLE 1

| | Composition 1 |
|---|---|
| HTN (vol. %) | 70 |
| Modified-EPDM (vol. %) | 5 |
| Talc (vol. %) | 25 |
| Thermal Conductivity (W/mK) | 0.7 |

What is claimed is:

1. An encapsulated stator assembly comprising
(a) a stator core comprising laminated electromagnetic steel sheets and further comprising wire wound coils;
(b) an insulator being positioned between the stator core and the wire wound coils;
(c) an encapsulating polymer composition substantially encapsulating the stator core and the wire wound coils and the insulator; and
(d) an adhesive component interfaced between the stator core (a) and the encapsulating polymer composition (c);
wherein the encapsulating polymer composition comprises a thermally conductive polymer composition having a thermal conductivity of at least about 0.6 W/mK.

2. The stator assembly of claim 1 wherein the stator core further comprises teeth having the wire wound coils positioned thereon and having an insulator over molded under the wire wound coils and wherein the insulator and the encapsulating polymer composition individually comprise a thermally conductive polymer composition having a thermal conductivity of at least about 0.6 W/mk.

3. The stator assembly of claim 2 wherein the thermally conductive polymer is selected from the group consisting of thermoplastic polymers and thermosetting polymers and the thermally conductive polymer contains groups that are reactive with the adhesive component (c).

4. The stator assembly of claim 3 wherein the thermally conductive polymer comprises a thermoplastic polymer and a toughening agent.

5. The stator assembly of claim 1 wherein the adhesive component is a primer coated on the stator core (a).

6. The stator assembly of claim 5 wherein the primer comprises a coupling agent selected from the group consisting of silane, titanate, zirconate, aluminate and zircoaluminate.

7. The stator assembly of claim 6 wherein the thermally conductive polymer material comprises a thermoplastic polymers having groups which can react with the coupling agents of the primer.

8. A process for forming an encapsulated stator assembly with a polymer composition which stator assembly comprises a stator core comprising laminated electromagnetic steel sheets and further comprises wire wound coils having an insulator positioned between the coils and the stator core and which comprises the following steps in any order:
applying an adhesive component at an interfaced between the stator core and the encapsulating polymer composition being subsequently applied; and
encapsulating the stator assembly with a polymer composition thereby substantially encapsulating the stator core and the wire would coils; and
wherein the polymer composition comprises a thermally conductive polymer composition having a thermal conductivity of at least about 0.6 W/mK.

9. A motor comprising the encapsulated stator assembly of claim 1.

10. A generator comprising the encapsulated stator assembly of claim 1.
